(19) United States
(12) Patent Application Publication
(10) Pub. No.: US 2012/0207170 A1
(43) Pub. Date: Aug. 16, 2012

(54) VIRTUAL PRIVATE LAN SERVICE PACKET PROCESSING

(75) Inventors: Nirmesh Patel, Kanata (CA); Erel Ortacdag, Ottawa (CA)

(73) Assignee: ALCATEL-LUCENT CANADA, INC., Ottawa (CA)

(21) Appl. No.: 13/028,362

(22) Filed: Feb. 16, 2011

(51) Int. Cl. H04L 12/28

(52) U.S. Cl. 370/395.53

(57) ABSTRACT

Embodiments of the invention are directed to processing Virtual Private LAN Service (VPLS) packets. Each VPLS packet is processed in two stages. In a first stage Layer 2 and Layer 3 headers are parsed from the packet to obtain an Ethernet frame and Traffic management characteristics are determined according to the L3 header. In a second stage a type of Ethernet frame is determined, as either one requiring replication or not, and the Ethernet frame is forwarded in accordance with the TM characteristics based on the determined frame type. This approach allows for a modular implementation which provides enables high performance and efficient utilization of processing resources.

### FIELD OF THE INVENTION

The invention is directed to processing data packets in a data communication network, particularly to processing Virtual Private LAN Service (VPLS) packets requiring unicast or multicast forwarding.

### BACKGROUND OF THE INVENTION

Virtual Private Local Area Network (LAN) Service (VPLS) is a Virtual Private Network (VPN) technology that provides multipoint communication over Ethernet networks and is described in Internet Engineering Task Force (IETF) RFC 4761 and RFC 4762. When an Ethernet packet is received in network ingress direction, normally it contains network Layer 2 and Layer 3 encapsulations. Examples of network Layer 2 encapsulation are Ethernet, Multi-Link Point to Point Protocol (MLPPP) and Point to Point Protocol (PPP). Examples of network Layer 3 encapsulation are Multi-Protocol Label Switching (MPLS) protocol and Internet Protocol (IP) Generic Routing Encapsulation (GRE) protocol. A network Layer 3 header provides traffic management characteristics for a given packet. After network Layer 2 and Layer 3 headers are removed, the remaining packet is an Ethernet frame. A destination Media Access Control (MAC) address of the Ethernet frame is then looked up in a forwarding database. If there is no match for a unicast packet or if the packet has a multicast or a broadcast destination address then this packet needs to be duplicated to flood every endpoint configured in the VPLS service. A packet that needs to be duplicated must follow different traffic management rules than a packet with a known unicast destination MAC address. Traffic management rules typically include rate limiting parameters, scheduling priority and parameters, and congestion profiles.

The aforementioned operations involved in processing VPLS packets may in some cases consume considerable resources of a network processor in a switch or router that is communicating VPLS packet traffic. Therefore, a way of efficiently using network processor resources to process VPLS traffic is desired.

### SUMMARY

According to an aspect of the invention a method of processing a Virtual Private LAN Service (VPLS) packet is provided. The method comprises: performing at a first module the steps of: parsing a Layer 2 (L2) header and a Layer 3 (L3) header from the VPLS packet to obtain an Ethernet frame, retrieving traffic management (TM) characteristics based on the L3 header, and forwarding the Ethernet frame and the TM characteristics to a second module; and at the second module performing the steps of: determining a type (Known unicast, Unknown unicast, Broadcast, Multicast) of the Ethernet frame, and processing the Ethernet frame in accordance with the TM characteristics based on the type of the Ethernet frame.

In some embodiments the method further comprises: determining if the Ethernet frame is of a first type requiring unicast forwarding or of a second type requiring multicast forwarding; retrieving a unicast queue identifier and a multicast queue identifier; retrieving a unicast congestion profile and a multicast congestion profile; assigning, responsive to the Ethernet frame being of the first type, the unicast queue identifier and the unicast congestion profile to the Ethernet frame; and assigning, responsive to the Ethernet frame being of the second type, the multicast queue identifier and the multicast congestion profile to the Ethernet frame.

According to another aspect of the invention a device for processing a Virtual Private LAN Service (VPLS) packet is provided. The device comprises: a Layer 2/Layer 3 (L2/L3) parsing module operable to receive the VPLS packet and parse an L2 header and an L3 header from the VPLS packet to obtain an Ethernet frame and to forward the Ethernet frame; and a VPLS parsing module operable to receive the Ethernet frame and to determine if the Ethernet frame requires unicast of multicast forwarding, wherein the L2/L3 parsing module is further operable to retrieve a set of traffic management (TM) characteristics based on the L3 header and to provide the set of TM characteristics to the VPLS parsing module, and wherein the VPLS parsing module is further operable to select a queue of a plurality of queues based on the set of TM characteristics and whether unicast or multicast forwarding of the Ethernet frame is required.

In some embodiments the VPLS parsing module is further operable to apply a first congestion profile in accordance with the set of TM characteristics and a determination that unicast forwarding of the Ethernet frame is required, and to apply a second congestion profile in accordance with the set of TM characteristics and a determination that multicast forwarding of the Ethernet frame is required.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 depicts a device for processing VPLS packets according to an embodiment of the invention.

FIG. 2 depicts a method of processing VPLS packets according to another embodiment of the invention.

In the figures like features are denoted by like reference characters.

### DETAILED DESCRIPTION

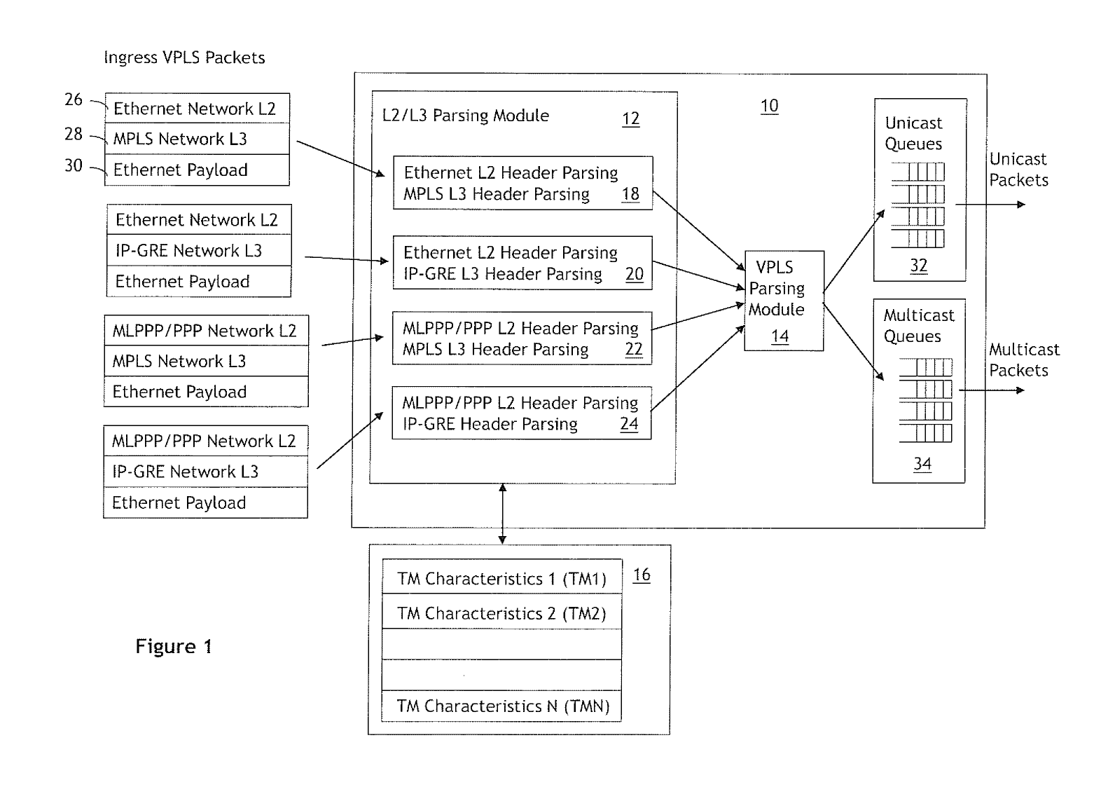

FIG. 1 depicts a device 10 for processing VPLS packets. The device 10 splits network frame processing into two modules, first is a Layer 2/Layer 3 (L2/L3) parsing module 12 and second is a VPLS processing module 14. The L2/L3 parsing module 12 is responsible for retrieving a set of TM characteristics (e.g. TM1) from a data store of TM characteristics 16, wherein the set of TM characteristics (e.g. TM1) includes characteristics for both known unicast packets and packets needing duplication. The L2/L3 parsing module 12, which may include encapsulation protocol-specific sub-modules 18, 20, 22, 24, then removes a Layer 2 header 26 and a Layer 3 header 28 from the VPLS packet. The L2/L3 parsing module 12 then forwards the resulting Ethernet frame 30 to the VPLS processing module 14 along with the retrieved set of TM characteristics. The VPLS processing module 14 then parses the Ethernet frame 30 for the purpose of forwarding the Ethernet frame 30. Part of the VPLS parsing operation requires VPLS processing to identify a frame type of the Ethernet frame 30 as being either known unicast frame or frame needing duplication (e.g. unknown unicast, broadcast, or multicast). At this point certain characteristics (e.g. queue identifiers and congestion profiles) of the set of TM characteristics (e.g. TM1) propagated from the L2/L3 parsing module 12 are applied by the VPLS parsing module 14 to the Ethernet frame 30 based on its frame type which results in a unique TM behavior according to the frame type.

Advantageously, due to modularization, program code sharing among different sub-modules 18, 20, 22, 24 can be exploited resulting in optimized use of code space. Moreover, parsing of the VPLS packet is done once, by the L2/L3 parsing module 12; thereby making efficient use of network processor resources. Portability of the implementation, e.g. to other types of network processors or FPGA, is high due to modularization of the implementation.

A traffic management policy is created on a network Layer 2/Layer 3 interface which in turn dictates how received unicast packets having a known destination address (referred to herein as known unicast packets) and packets needing duplication (e.g. unknown unicast, broadcast, or multicast) are to be treated in the router or switch. After the VPLS packet is received only the Layer 2 and Layer 3 headers are parsed to retrieve the set of TM characteristics. The set of TM characteristics (e.g. TM1) includes two different queue IDs identifying which queue to use for this packet and two different congestion profiles describing how to treat the packet under congestion. Both queue IDs and congestion profiles are retrieved because the L2/L3 parsing module 12 does not know if the VPLS packet received is a known unicast packet or a packet needing duplication. The L2/L3 parsing module 12 then removes Layer2 and Layer3 headers and forwards the Ethernet frame 30 to VPLS parsing module 14 along with both queue identifiers and congestion profiles.

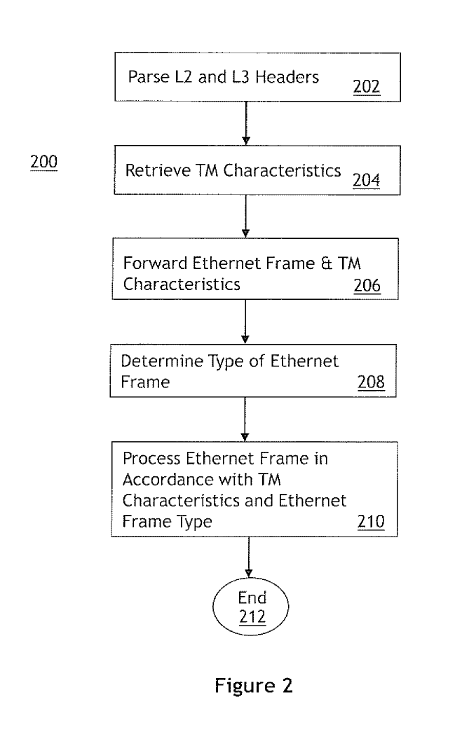

The VPLS parsing module 14 parses the received Ethernet frame 30 and identifies the Ethernet frame 30 as being either known unicast or a packet needing duplication by performing a lookup in a forwarding database based on a destination address included in the Ethernet frame 30. The VPLS parsing module 14 then assigns a queue identifier and a congestion profile to the Ethernet frame 30 according to the frame type of the Ethernet frame 30. The assigned queue identifier and congestion profile are each one of those received from the L2/L3 parsing module 12 with the Ethernet frame 30. In this manner unique traffic management behavior is provided based on the frame type used. In the case that the Ethernet frame 30 requires unicast forwarding the VPLS parsing module 14 forwards the Ethernet frame 30 to a given unicast queue of a plurality of unicast queues 32, the unicast queue being identified by the assigned queue identifier, and the Ethernet frame 30 is unicasted from the switch or router along with other unicast packets. In the case that the Ethernet frame 30 requires multicast forwarding, the VPLS parsing module 14 forwards the Ethernet frame 30 to a given multicast queue of a plurality of multicast queues 34, the multicast queue being identified by the assigned queue identifier, and the Ethernet frame 30 is multicasted from the switch or router along with other multicast packets. FIG. 2 depicts a method 200 of processing VPLS packets according to another embodiment of the invention. The method 200 starts by parsing 202 an L2 header and an L3 header from a received VPLS packet to obtain an Ethernet frame. Next, traffic management (TM) characteristics are retrieved 204 based on the L3 header. A unicast queue identifier and a multicast queue identifier are retrieved 204 as well as a unicast congestion profile and a multicast congestion profile. The steps of parsing 202 and retrieving 204 are typically performed in a first module. The Ethernet frame and the TM characteristics are then forwarded 206 to a second module. The second module then determines 208 a type of the Ethernet frame; whereby the Ethernet frame is determined 208 as being of a first type requiring unicast forwarding or of a second type requiring multicast forwarding. The second module then processes 210 the Ethernet frame in accordance with the TM characteristics based on the type of the Ethernet frame. The processing 210 includes assigning, responsive to the Ethernet frame being of the first type, the unicast queue identifier and the unicast congestion profile to the Ethernet frame; or assigning, responsive to the Ethernet frame being of the second type, the multicast queue identifier and the multicast congestion profile to the Ethernet frame.

Advantageously, this invention uses a modular approach to assign unique TM characteristic based on the frame type. This approach allows extensive code reuse and also avoids reparsing the VPLS packet in each module; thereby providing good VPLS packet processing performance and efficient use of network processor resources.

Advantageously, some embodiments enable reuse of the VPLS parsing module 14 by simply connecting different type of Layer2/Layer3 parsing modules to VPLS parsing module 14 which makes the VPLS parsing module 14 portable. This portability helps to shorten development time required for designing new VPLS processing devices that support new Layer 2 interfaces.

Numerous modifications, variations and adaptations may be made to the embodiments of the invention described above without departing from the scope of the invention, which is defined in the claims.

Embodiments of the device 10 would typically be implemented in a network processor including the L2/L3 parsing module 12, the VPLS parsing module 14, and the unicast 32 and multicast queues 34. The data store of TM characteristics 16 may be included in the device 10 or may be external to it. Likewise, in some embodiments the unicast queues 32 and additionally or alternatively the multicast queues 34 could be external to the device 10. In fact, even the L2/L3 parsing module 12 and the VPLS parsing module 14 could be implemented in separate devices. Embodiments are not limited to network processors, as microprocessors, field programmable gate arrays (FPGAs), and application specific integrated circuits (ASICs), taken individually or in any combination, could be used.

What is claimed is:

1. A method of processing a Virtual Private LAN Service (VPLS) packet comprising:
in a first module:
parsing a Layer 2 (L2) header and a Layer 3 (L3) header from the VPLS packet to obtain an Ethernet frame;
retrieving traffic management (TM) characteristics based on the L3 header;
forwarding the Ethernet frame and the TM characteristics to a second module;
in the second module:
determining a type of the Ethernet frame; and
processing the Ethernet frame in accordance with the TM characteristics based on the type of the Ethernet frame.

2. The method of claim 1 wherein determining comprises:
determining if the Ethernet frame is of a first type requiring unicast forwarding or of a second type requiring multicast forwarding.

3. The method of claim 2 wherein retrieving comprises:
retrieving a unicast queue identifier and a multicast queue identifier; and
retrieving a unicast congestion profile and a multicast congestion profile.

4. The method of claim 3 wherein processing comprises:
assigning, responsive to the Ethernet frame being of the first type, the unicast queue identifier and the unicast congestion profile to the Ethernet frame; and
assigning, responsive to the Ethernet frame being of the second type, the multicast queue identifier and the multicast congestion profile to the Ethernet frame.

5. The method of claim 1 wherein
determining comprises determining that the Ethernet frame is of a first type requiring unicast forwarding,
retrieving comprises retrieving a unicast queue identifier, and
processing comprises assigning the unicast queue identifier to the Ethernet frame.

6. The method of claim 5 wherein
retrieving further comprises retrieving a unicast congestion profile, and
processing further comprises assigning the unicast congestion profile to the Ethernet frame.

7. The method of claim 1 wherein
determining comprises determining that the Ethernet frame is of a second type requiring multicast forwarding,
retrieving comprises retrieving a multicast queue identifier, and
processing comprises assigning the multicast queue identifier to the Ethernet frame.

8. The method of claim 6 wherein
retrieving further comprises retrieving a multicast congestion profile, and
processing further comprises assigning the multicast congestion profile to the Ethernet frame.

9. A device for processing a Virtual Private LAN Service (VPLS) packet comprising:
a Layer 2/Layer 3 (L2/L3) parsing module operable to receive the VPLS packet and parse an L2 header and an L3 header from the VPLS packet to obtain an Ethernet frame and to forward the Ethernet frame; and
a VPLS parsing module operable to receive the Ethernet frame and to determine if the Ethernet frame requires unicast of multicast forwarding,
wherein the L2/L3 parsing module is further operable to retrieve a set of traffic management (TM) characteristics based on the L3 header and to provide the set of TM characteristics to the VPLS parsing module, and
wherein the VPLS parsing module is further operable to select a queue of a plurality of queues based on the set of TM characteristics and whether unicast or multicast forwarding of the Ethernet frame is required.

10. The device of claim 9 wherein the device further comprises a plurality of sets of TM characteristics that include the set of TM characteristics.

11. The device of claim 9 wherein the device further comprises the plurality of queues.

12. The device of claim 11 wherein the plurality of queues comprise a plurality of unicast queues and a plurality of multicast queues.

13. The device of claim 12 wherein the VPLS parsing module is further operable to apply a first congestion profile in accordance with the set of TM characteristics and a determination that unicast forwarding of the Ethernet frame is required.

14. The device of claim 12 wherein the VPLS parsing module is further operable to apply a second congestion profile in accordance with the set of TM characteristics and a determination that multicast forwarding of the Ethernet frame is required.

15. The device of claim 9 wherein the VPLS parsing module is further operable to forward the Ethernet frame to the queue.
